(19) United States
(12) Patent Application Publication
(10) Pub. No.: US 2013/0055958 A1
(43) Pub. Date: Mar. 7, 2013

(54) Pet nursing jacket

(71) Applicant: David McKenzie, Mount Pleasant, PA (US)

(72) Inventor: David McKenzie, Mount Pleasant, PA (US)

(21) Appl. No.: 13/223,683

(22) Filed: Sep. 1, 2011

(51) Int. Cl. A01K 5/00; A01K 29/00

(52) U.S. Cl. 119/72; 119/850

(57) ABSTRACT

The present invention is a pet nursing jacket that allows a pet owner to feed puppies, kittens or other baby animals. The pet nursing jacket includes a base jacket that is placed on a feeding animal, a plurality of hook and loop fasteners that are disposed on the base jacket to open and close the base jacket to allow the base jacket to be placed around and removably secured to the feeding animal, a thermostat disposed on the base jacket that indicates a temperature of the feeding animal and a fur coating disposed on the exterior surface of the base jacket. The jacket also includes a baby bag that holds liquid food that includes a plurality of nipples, a fluid gauge that indicates a quantity of the liquid food stored in the baby bag and a heart beat device that generates a simulated heart beat.

### TECHNICAL FIELD & BACKGROUND

Milk from a dog or cat that recently gave birth can become contaminated making the milk toxic to drink, leaving the owner responsible for providing nourishment to the litter of the dog or cat. Small animals and pets have to be fed on a strict program that meets their dietary needs, which may be time and energy consuming for the individual responsible for them.

The present invention generally relates to a pet jacket. More specifically, the invention is a pet nursing jacket.

It is an object of the invention to provide a pet nursing jacket that allows a pet owner to feed puppies, kittens and other suitable baby animals according to their own schedule.

It is an object of the invention to provide a user a pet nursing jacket that offers comfort and security to any feeding puppies or kittens while they are being fed.

It is an object of the invention to provide a user a pet nursing jacket that allows the user to feed any feeding puppies, kittens or other suitable baby animals hands-free.

What is really needed is a pet nursing jacket that allows a pet owner to feed puppies, kittens and other suitable baby animals according to their own schedule that offers comfort and security to any feeding puppies or kittens while they are being fed and that allows the user to feed any feeding puppies, kittens or other suitable baby animals hands-free.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates an environmental side perspective view of a pet nursing jacket, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

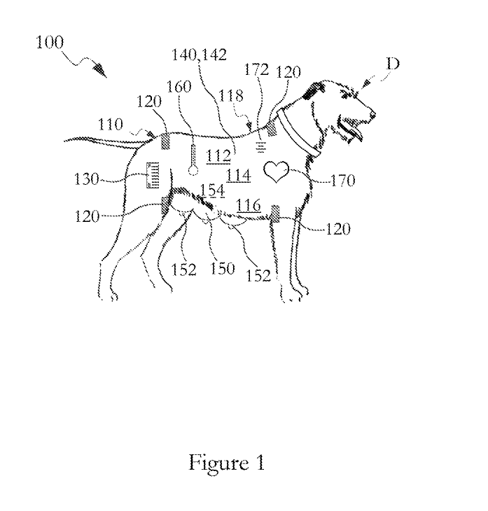

FIG. 1 illustrates an environmental side perspective view of a pet nursing jacket 100, in accordance with one embodiment of the present invention. The pet nursing jacket 100 allows a pet owner to feed puppies, kittens and other suitable baby animals according to their own schedule that offers comfort and security to any feeding puppies, kittens or other suitable animals while they are being fed and that allows the user to feed any feeding puppies, kittens or other suitable baby animals hands-free.

The pet nursing jacket 100 includes a base jacket 110, a plurality of hook and loop fasteners 120, a thermostat 130, a fur coating 140, a baby bag 150, a fluid gauge 160 and a heart beat device 170.

The base jacket 110 has a top portion 112, two side portions 114, a bottom portion 116 and an exterior surface 118 and is placed on a dog D, a cat or other suitable animal that will be wearing the pet nursing jacket 100. The hook and loop fasteners 120 are disposed on the top portion 112 and the bottom portion 116 of the base jacket 110 and are utilized to open and close the base jacket 110 to allow the base jacket 110 to be placed around and removably secured to the dog D, cat or other suitable animal. The hook and loop fasteners 120 can however, be disposed on any suitable portions of and in any suitable quantity on the base jacket 110. The thermostat 130 is disposed on one of the side portions 114 of the base jacket 110, although the thermostat 130 can be disposed on any suitable portion of the base jacket 110. The thermostat 130 indicates the temperature of the dog D or suitable animal wearing the pet nursing jacket 100. The fur coating 140 is typically disposed throughout the exterior surface 118 of the base jacket 110 and serves to comfort the puppies, kittens or other suitable baby animals being nursed by the pet nursing jacket 100. The fur coating 140 can be disposed over the entire exterior surface 118 of the base jacket 110 or any suitable portion thereof. The fur coating 140 is typically made of artificial or faux fur 142 however the fur coating 140 can be made of any suitable type of fur. The baby bag 150 is disposed on the bottom portion 116 of the base jacket 110 and includes a plurality of nipples 152 that the puppies, kittens or other suitable animals can suck on to receive the liquid food 154 contained and dispensed from the baby bag 150. The baby bag 150 typically utilizes 8 nipples 152 and the nipples 152 are removably attached to the bottom 116 of the base jacket 110 with the hook and loop fasteners 120. The presence of 8 nipples 152 is an advantage since most litters are 8 puppies, kittens or other suitable baby animals so that the nipples 152 can accommodate a full litter if needed or desired. The nipples 152 are made of latex but can be made of any other suitable material as well. The baby bag 150 holds liquid food 154 that is typically milk, a substitute milk product or other suitable liquid food that can be contained and dispersed from the baby bag 150. The fluid gauge 160 is typically disposed on one of the sides 114 of the base jacket 110 however the fluid gauge 150 can be disposed on any suitable location on the base jacket 110. The fluid gauge 160 indicates a level of liquid food 154 stored in the baby bag 150 being fed to the puppies, kittens or other suitable baby animals. The heart beat device 170 generates a simulated heart beat to further comfort and sooth any puppies, kittens or other suitable baby animals feeding on the pet nursing jacket 100. The heart beat device 170 is typically disposed on one of the sides 114 of the base jacket 110 however the heart beat device 170 can be disposed on any suitable portion of the base jacket 110. The heart beat device 170 also includes a rechargeable battery 172 that provides power to the heart beat device 170.

The pet nursing jacket allows puppies, kittens and other suitable animals to feed on their own schedule. The pet nursing jacket features a rechargeable battery-powered heart beat device that generates a plurality of heartbeats providing a simulated feeling that the suitable mother animal is present. Milk is dispersed from a baby bag which has eight life-like latex nipples connected to the pet nursing jacket by a plurality of hook and loop fasteners and a fluid gauge to aid the user in monitoring the liquid food supply. The pet nursing jacket will be readily available in various retail stores. The pet nursing jacket features a faux fur covered device as well as liquid food that can heat up to the animal's body temperature. The pet nursing jacket is designed to make small young pets feel comfortable and secure while offering owners a hands-free feeding experience.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A pet nursing jacket that allows a pet owner to feed one or more puppies, kittens or other baby animals, comprising:
a base jacket with a top portion, two side portions, a bottom portion and an exterior surface that is placed on a feeding animal;
a plurality of hook and loop fasteners that are disposed on said base jacket to open and close said base jacket to allow said base jacket to be placed around and removably secured to said feeding animal;
a thermostat disposed on said base jacket that indicates a temperature of said feeding animal;
a fur coating disposed on said exterior surface of said base jacket to comfort said puppies, kittens or other baby animals being fed;
a baby bag that holds liquid food disposed on said bottom portion of said base jacket that includes a plurality of nipples to feed said puppies, kittens or other baby animals;
a fluid gauge that indicates a quantity of said liquid food stored in said baby bag being fed to said puppies, kittens or other baby animals; and
a heart beat device that generates a simulated heart beat to further comfort and sooth said puppies, kittens or other suitable baby animals feeding on said pet nursing jacket.

2. The pet nursing jacket according to claim 1, wherein said feeding animal is a dog.

3. The pet nursing jacket according to claim 1, wherein said fur coating is made of faux or artificial fur.

4. The pet nursing jacket according to claim 1, wherein said nipples are made of latex.

5. A pet nursing jacket that allows a pet owner to feed one or more puppies, kittens or other baby animals, comprising:
a base jacket with a top portion, two side portions, a bottom portion and an exterior surface that is placed on a feeding animal;
a plurality of hook and loop fasteners that are disposed on said top portion and said bottom portion of said base jacket base jacket to open and close said base jacket to allow said base jacket to be placed around and removably secured to said feeding animal;
a thermostat disposed on one of said side portions said base jacket that indicates a temperature of said feeding animal;
a fur coating disposed on said exterior surface of said base jacket to comfort said puppies, kittens or other baby animals being fed;
a baby bag that holds liquid food disposed on said bottom portion of said base jacket that includes a plurality of nipples to feed said puppies, kittens or other baby animals;
a fluid gauge that indicates a quantity of said liquid food stored in said baby bag being fed to said puppies, kittens or other baby animals; and
a heart beat device that generates a simulated heart beat to further comfort and sooth said puppies, kittens or other suitable baby animals feeding on said pet nursing jacket.

6. The pet nursing jacket according to claim 5, wherein said feeding animal is a dog.

7. The pet nursing jacket according to claim 5, wherein said fur coating is made of faux or artificial fur.

8. The pet nursing jacket according to claim 5, wherein said nipples are made of latex.

9. The pet nursing jacket according to claim 5, wherein said nipples are removably attached to said bottom of said base jacket.

10. The pet nursing jacket according to claim 9, wherein said nipples are removably attached with said hook and loop fasteners.

11. The pet nursing jacket according to claim 10, wherein said nipples include 8 nipples.

12. A pet nursing jacket that allows a pet owner to feed one or more puppies, kittens or other baby animals, comprising:
a base jacket with a top portion, two side portions, a bottom portion and an exterior surface that is placed on a feeding animal;
a plurality of hook and loop fasteners that are disposed on said top portion and said bottom portion of said base jacket base jacket to open and close said base jacket to allow said base jacket to be placed around and removably secured to said feeding animal;
a thermostat disposed on one of said side portions said base jacket that indicates a temperature of said feeding animal;
a fur coating disposed on said exterior surface of said base jacket to comfort said puppies, kittens or other baby animals being fed;
a baby bag that holds liquid food disposed on said bottom portion of said base jacket that includes a plurality of nipples to feed said puppies, kittens or other baby animals;
a fluid gauge that is disposed on one of said sides that indicates a quantity of said liquid food stored in said baby bag being fed to said puppies, kittens or other baby animals; and
a heart beat device that is disposed on one of said sides that generates a simulated heart beat to further comfort and sooth said puppies, kittens or other suitable baby animals feeding on said pet nursing jacket.

13. The pet nursing jacket according to claim 12, wherein said feeding animal is a dog.

14. The pet nursing jacket according to claim 12, wherein said fur coating is made of faux or artificial fur.

15. The pet nursing jacket according to claim 12, wherein said nipples are removably attached to said bottom of said base jacket.

16. The pet nursing jacket according to claim 15, wherein said nipples are removably attached with said hook and loop fasteners.

17. The pet nursing jacket according to claim 16, wherein said nipples include 8 nipples.

18. The pet nursing jacket according to claim 17, wherein said nipples are made of latex.

19. The pet nursing jacket according to claim 12, wherein said heart beat device includes a battery that provides power to said heart beat device.

20. The pet nursing jacket according to claim 19, wherein said battery is a rechargeable battery.
